(19) United States
(12) Patent Application Publication
(10) Pub. No.: US 2003/0216986 A1
(43) Pub. Date: Nov. 20, 2003

(54) System and method for information exchange

(76) Inventor: Adnan Hassan, Washington, DC (US)

Correspondence Address: MICHAEL D. BEDNAREK, SHAW PITTMAN LLP, 1650 TYSONS BOULEVARD, MCLEAN, VA, 22102, US

(21) Appl. No.: 10/377,759

(22) Filed: Mar. 4, 2003

Related U.S. Application Data
(60) Provisional application No. 60/361,342, filed on Mar. 5, 2002.

(51) Int. Cl. G06F 17/60

(52) U.S. Cl. 705/35

(57) ABSTRACT

The present invention relates to a method for information exchange allowing a first entity to post a project plan with the project plan requiring one or more inputs from other entities. One or more entities may then respond to the posting, offering to fulfill one or more of the inputs. Subsequently, the first entity may review the responses from the one or more entities to select the inputs necessary for the project.

This application claims the benefit of U.S. Provisional Application No. 60/361,342, filed Mar. 5, 2002, which is herein incorporated by reference in its entirety.

### BACKGROUND

1. Field of the Invention

The present invention relates generally to a system and method for information exchange among members of a given business sector and/or business region through interactive Internet-based secure user-accessed web-sites.

2. Background of the Invention

Successful business ventures involve many players specializing and participating in different aspects of the venture, including entrepreneurs, managers, investors, consultants, research and development personnel, marketers, legal teams, government regulators, industry specialists, and many other players. Although a successful venture involves input from the above exemplary list of experts, an entrepreneur or project manager tasked with planning a particular project may not have the financial resources to hire all such experts. The cost factor may be prohibitive of the project. Thus, the cost associated with seeking, hiring, and consulting with such experts may become so prohibitive that many projects will not be financially possible to pursue.

For example, if an entrepreneur plans to expand the cellular market infrastructure in a given undeveloped region, he or she must involve many different players. The entrepreneur must seek a government regulator to obtain a license to pursue this plan; a legal team to advise him of the legal extent of his property rights in the project and various contractual duties with personnel and other businesses; research and development personnel to scientifically develop this idea; various consultants to advise the entrepreneur during the development of the project; accounting and financial advisors to keep track of the cost issues involved with the project; and marketers to sell and advertise the idea and attract potential customers. There are many additional players that are involved in the successful implementation of this relatively simple business idea, to expand the cellular telephone market infrastructure in a given area. Many such additional players are industry-specific and are specialized to assist businesses involved in such industries.

There is a tremendous time and financial burden for the above entrepreneur who needs to seek and attempt to hire personnel that would assist him in the proposed business venture. This time and financial barrier is prohibitively large to many entrepreneurs because of the associated transaction costs. Such costs include, for example, long distance travel and communication to meet experts that may be interested in assisting this entrepreneur. Furthermore, even if experts are retained for a project, such experts may not be proficient or experienced in the particular type of project being developed.

Conversely, there may be contractors, such as, for example, cellular market industry-specific consultants, who are seeking to expand their consultation practice. However, such consultants are not aware that the entrepreneur above needs assistance that is in tune with their expertise. Thus, such experts may have to venture out of their region to seek business. This increase in time associated with travel and seeking new clients is costly and undesirable for the consultant.

Thus, there is a need for a method or system for information exchange that brings together entrepreneurs and experts, such that all parties may evaluate the products or services of the other, and thereby decrease transaction costs and minimize the barriers associated with locating personnel and funding such ventures. Furthermore, this information exchange should be an efficient forum for the rapid exchange of business opportunities, and should be easily accessible by members of this exchange.

### SUMMARY OF THE INVENTION

Broadly defined, the present invention relates to a forum for the rapid exchange of information within a given sector and/or region of business. The forum may be the basis for a private information exchange (“exchange”) that allows members of the exchange to submit projects that need assistance or seek out ventures that other members have posted. Within a given sector and/or region, members of the exchange will be able to seek specific contractors for assistance or discover specific projects in which to invest finances or time. Thus, transaction costs associated with seeking and hiring personnel may be reduced. Furthermore, investors in a given region and/or market may be able to seek and keep track of particular projects in the region and/or market.

An exemplary embodiment of the present invention is a method for facilitating information exchange. Such a method includes presenting a forum for a given industry, wherein interested parties that seek to develop business in such an industry, display their products or services, and let other members of the forum consider such products and services. An example of such a forum is a secure Internet site. Such a forum may be remotely accessible, for example, through personal data assistants (PDA) or the like, thereby allowing members of the forum to evaluate posted products or services in real-time.

Another exemplary embodiment of the present invention is a system for facilitating information exchange between a project manager and a potential contractor. Such a system includes a forum to post a proposed or existing project. Such forum is accessible by members of the forum, which typically include contractors that are proficient in the industry related to the project. Furthermore, the contractors may respond to the project manager to assist in aspects of the project that the manager has indicated assistance is sought. An interaction occurs between the manager and the contractor. Such an interaction may be directly through the forum. A result of such an interaction may be creation of a bid or contract related to the project.

Another exemplary embodiment of the present invention is a method for seeking our projects in which to invest. This method includes an investor accessing an information exchange forum specific to a given region and/or industry. The investor considers the information that is presented in the exchange and evaluates which project would be beneficial. The investor communicates with a contact for the information that is beneficial and arranges for investment into a project described in the information.

According to another aspect of the present invention, a method of operating an information exchange forum for allowing the exchange of information among a first group of users comprising institutions that offer infrastructure projects, a second group of users comprising companies that complete work directly with the first group of users in connection with the projects of the first group of users and a third group of users comprising smaller contractors and subcontractors that work collaboratively with the second group of users is disclosed utilizing an electronic forum provided for information exchange. The first group of users, the second group of users and the third group of users may be provided with secured access to the information exchange. Users within the first group may also be allowed to list projects on the information exchange and update project terms and contacts for projects for which the first group users would like to bid out. In addition users within the second group of users may be allowed to bid on new projects, negotiate terms and track the on-going status of a project. Further, users within the second group of users may be allowed to receive bids from users within the third group of users so as to allow user within the second group of users to identify key prospective members of project syndicates.

### BRIEF DESCRIPTION OF THE DRAWINGS

FIG. 1 is a schematic of available Internet markets for a system and method according to the present invention and is based on specific variables.

FIG. 2 is a grid showing how various regions and sectors may be divided according to the invention.

FIG. 3 is an exemplary illustration of the differences in buyer-supplier interaction between pre-Internet, point-to-point e-commerce and the current marketplace scenario, according to an exemplary embodiment of the present invention.

### DETAILED DESCRIPTION OF THE INVENTION

The system and method of the present invention serve to address the shortcomings and problems in the market, for example, by reducing high transaction costs and barriers to market entry in a given industry. As used herein and throughout this disclosure, the “present invention” means an exemplary embodiment of a system and/or method according to the present invention.

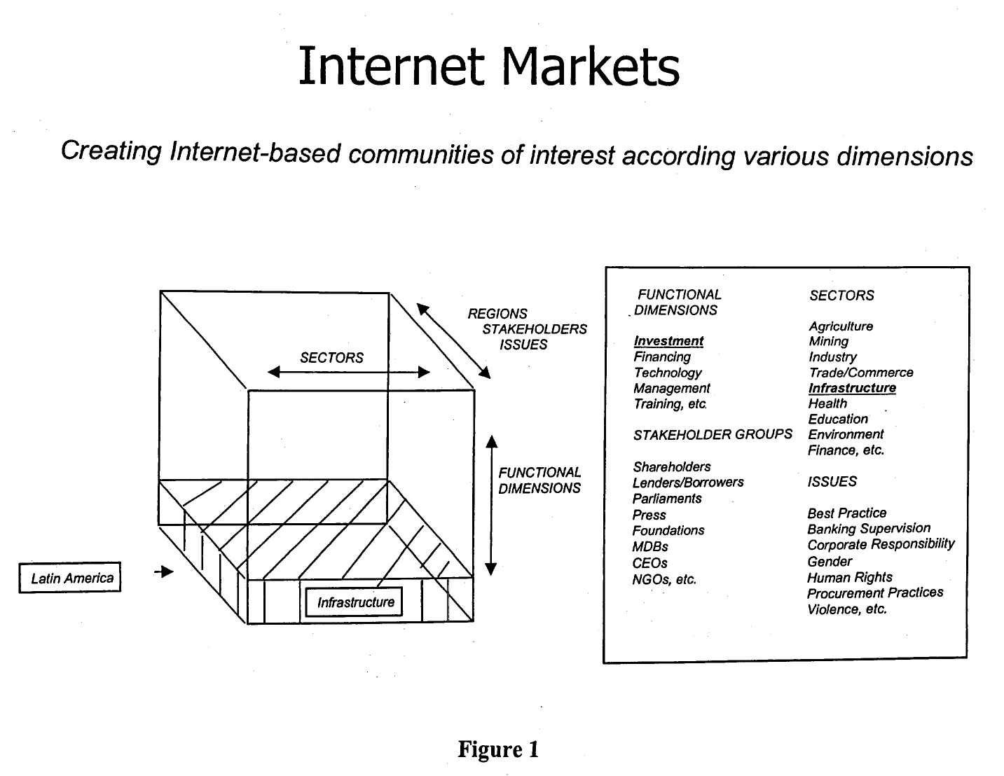

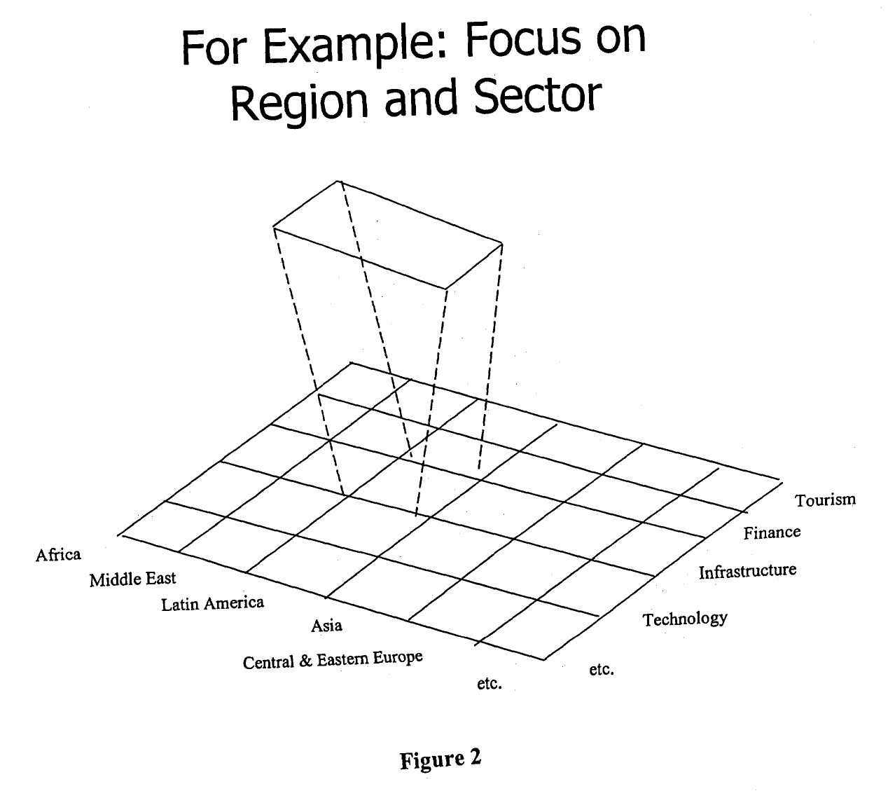

The present invention proposes a forum to bring together buyers and suppliers of products and services within a given market sector. This forum may be, for example, an information exchange. As used herein and throughout this disclosure, an “exchange” is an information exchange. This market sector may be any specialized market sector, including, but not limited to construction, banking, retail, communications, or the like. The present invention will establish itself as the leading on-line marketplace in the business-to-business (B2B), business to government (B2G), and government-to-government (G2G) space within specific sectors and/or regions, such as, for example, the Latin America and Caribbean infrastructure community. The exemplary embodiments that are described in this disclosure use Latin America and the Caribbean as merely an example of an exemplary region and the infrastructure industry as merely an example of a market sector. As used in the examples, “infrastructure” refers to railroads, roads, telephone systems, construction, sewage systems, or the like. The present invention may be applied to any other defined region and/or market sector, and is not intended to be limited to the Latin America and Caribbean region relating to infrastructure projects. As shown in FIG. 1, Internet markets relating to the Latin America region and the infrastructure sector is merely a small portion of the overall potential use of the present invention. FIG. 2 shows the particular region and sector used in the examples herein.

The present invention creates a state of the art e-commerce solution in the form of an information exchange that will control and manage an Internet community of buyers, sellers, and service providers for enterprises and governmental agencies seeking to lower costs and raise revenues via web-based technologies. This exchange will assist entities within the Latin America and Caribbean infrastructure communities in managing workflow, transferring knowledge and competitively procuring goods and services. The present invention addresses the ineffectiveness and inefficiencies in the current workflow process. The new marketplace will create value to both sides of the infrastructure projects, and at all stages of the process from project conception to final exit.

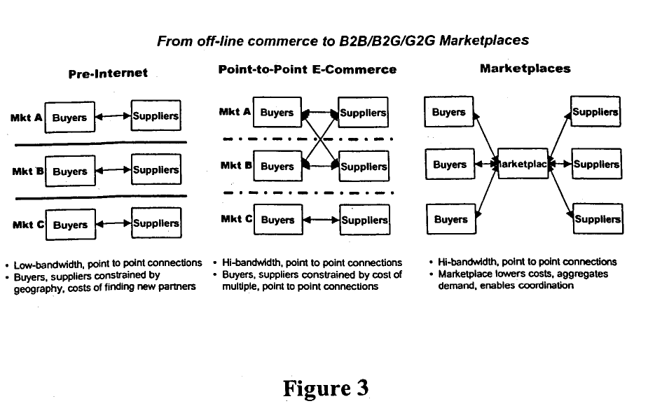

As shown in FIG. 3, the marketplace created by the present invention will be one that is accessible by all relevant buyers and suppliers of the market. In conventional pre-internet systems or current e-commerce systems, buyers and suppliers must seek each other out on an individual basis, and have no forum for aggregate exchange of information. This is one of the characteristics of the exchange according to the exemplary embodiments of the present invention.

The present invention is an exchange available for members that may contain the following basic functionality: project profiles, contacts, collaborators, messaging, project news, regulations, industry events and on-line forums; independent expert advice, custom reports, company ratings, project credit ratings, source of financing. Then the exchange may be open to the public with a marketing campaign to attract users to the site.

The present invention offers the Latin America and Caribbean infrastructure market a more efficient and effective alternative to the current process of completing infrastructure projects. The present invention creates efficiencies and provides solutions along each step of the workflow value chain from project conception to final exit from a project. The access to knowledge through knowledge repositories, libraries, and user groups coupled with the ability to competitively procure products and services will make the present invention the marketplace for infrastructure in Latin America and the Caribbean. The exchange will shift all players in the infrastructure community to a far more efficient marketplace, while introducing tremendous economies of scale, and significantly promoting the economic and political integration of the region.

Part of the success of an effective exchange includes obtaining commitments from large institutions and companies as customers, users of, and participants in the exchange. Further refinement of the exchange dashboard provides the greatest value impact by providing tools to improve management efficiencies at each stage of the workflow process for infrastructure projects. Furthermore, it is important to leverage existing contacts within the emerging markets and the technology community.

The present invention proposes to capitalize on the existing market inefficiencies in the Latin America and Caribbean infrastructure community by launching a vertical on-line exchange for infrastructure related activities in the region. The business model is to provide the infrastructure community in Latin America and the Caribbean a more practical and efficient means to manage workflow. An exemplary system according to the present invention is an exchange that will provide value to parties on both sides of the infrastructure projects. The access to information that the exchange will provide will help project sponsors conceptualize projects with greater chances for success. It will help them to determine feasibility, promote, design, close, construct, and operate their projects over much shorter periods of time and at lower costs than under the fragmented manner that is currently employed. The administrative efficiencies and access to intelligence information will provide value to project contractors. This win-win scenario creates the traction in the marketplace to draw participants into the exchange community.

A drawback to investing in certain regions, such as a foreign country, for example, Chile, is weaving through the maze of regulatory information pertinent to each project. An electronic marketplace would provide the consumer with the means of disseminating this information.

The project workflow value chain may comprise nine segments, each segment being individually assisted by and facilitated by the exchange. There is the initial concept, initial design, feasibility, promotion, final design, closing, construction, operation and maintenance, and exit. At each step along this chain, there are various tasks that need to be completed to get to the next stage. The present invention provides users with valuable information and tools at each stage that will relieve pain points, assist users in making informed decisions and move more efficiently and effectively through the stages.

At the Project Conception stage, a sponsor develops the concept of a project and attempts to develop the optimal plan for its construction. Some of the key tasks include the site selection, size of project, financing, and key partners. The present invention will allow the entity that is conceptualizing such a project to have access to experts around the world to obtain input about the best way to plan the project. The present invention will provide for a level of anonymity, if desired, so that the user could obtain such information without presenting the identity of the sponsoring agency or entity.

At the Initial Design stage, key tasks include the initial decisions regarding technology, partners, financing, and specifications. Presently, regulatory practices and the approval process make it very difficult to make changes once the decisions have been made. The present invention will provide the user with the tools that will allow the users to obtain relevant information to make informed decisions for each of these key tasks. The tools within the site also will facilitate an easier and faster way to make any changes because the forms and processes will be available on line to facilitate communication at all levels throughout the value chain.

At the feasibility stage, the sponsor needs analysis regarding the overall feasibility of the project as it pertains to technical, financial, legal, environmental, and regulatory matters. For each of these areas, there is a process for assuring the approval. The present invention will provide the users with access to the best analysts and will provide a rating or “seal of approval” for analysts to assist users with the decision of which analysts or consultants to choose. The forms, system and process for approval will be accessible through the site that provides a more streamlined process for obtaining approval and assuring that the proper parties have access to the appropriate information.

For Promotion, the sponsor needs to provide a clear and detailed project description and broadcast it to the community in hopes of attracting the best service providers at competitive prices. The present invention will provide the mechanism for uploading project information to the exchange so that it is available to a worldwide community rather than a very localized community. This functionality will provide the sponsors with a much larger pool of prospective service providers and will save significant amounts of money that is presently spent in printing, advertising mailing, and otherwise delivering such information to the community. Changes and amendments to project specifications will be easily made and communicated to the community.

At the Final Design stage, all of the detail work needs to be complete. Tasks include having detail engineering documents, equipment selection, selection of EPC firms, scheduling of materials, labor, contracting and subcontracting, and financing plans. The present invention will provide a tremendously more efficient process for document flow and approval, due diligence, and a transparent process where parties delaying the process can be easily identified and contacted.

At the Closing stage, all parts of the project are finalized and final due diligence is performed. Under the current system, this process often takes up to a year to complete, and sponsors plan for this process to take at least one year. The present invention provides an efficient means for the document flow in this stage, which should tremendously reduce the period of time it takes to close on a project. The exchange will provide high level, secure communication, transfer of legal and financial documents and a forum for negotiation.

For Project Construction, deadline management is a key task. The exchange will provide users with the tools for planning the construction process and for tracking progress. Procurement of materials, scheduling of labor, and scheduling of construction will be possible through the exchange.

For Operation and Maintenance, key tasks include scheduling and procurement. The exchange will provide tools for both of these tasks and allow the user access to a global community to obtain the best product at the most competitive price.

The Exit stage is where an equity holder in a project desires to sell its interest in the project. The present invention will provide a means for the entity to advertise its asset, exchange information with interested parties, negotiate terms, and close the transaction.

In a particular embodiment of a system and method according to the present invention, there will be members of the exchange. A multi-tier, for example, three, membership structure will exist. A first tier will be reserved for the 200 largest regional and global institutions that offer the majority of projects. A second tier will be comprised of approximately 1,000 regional and global companies that complete the majority of the work in the projects of the tier one institutions. A third tier will be comprised of approximately 10,000 smaller contractors and subcontractors that work collaboratively with the second tier companies. All members will be provided with secured access to the exchange.

Optionally, the exchange may offer the following:

the institutions promoting infrastructure projects the ability to list, change and update project terms and contacts for projects for which the institutions would like to bid out to the community;

a user the ability to bid on new projects, negotiate terms and track the ongoing status of a project;

a user the ability to identify key prospective members of project syndicates, and participants, such as consultants;

a user the ability to begin establishing a syndicate for a given project.

users the ability to electronically communicate in a secure environment with the membership;

a news updates regarding particular projects; the ability to list/view job openings and/or services available.

Optionally, the exchange may provide the following:

aggregation of exchange intelligence information based on archived activity information;

web pages to exchange members to enable them to present and manage information on their company;

online fulfillment of regulatory filings.

Optionally, the exchange may enable:

a user to solicit objective, third party industry advice from an expert with respect to a particular project. This advice could be written into a customized report;

users to obtain a credit rating reports from local or international credit rating agencies;

users to submit proposals for financing to the relevant local, national or international financial institutions that are involved with the financing of infrastructure, of FDI investments.

Optionally, the exchange may allow users:

to order custom reports on a particular subject that may relate to a project in which they are interested;

to assess a sponsor's market reputation through a Dun and Bradstreet style report;

to receive regulatory and legal information that they might need to prepare a tender bid or offer, or engineering design features that may have to conform with existing laws;

to enter chat rooms and discuss aspects of a project or an industry;

to bid electronically on project procurement.

Optionally, the exchange updates users on events that are topical in any industry in which the member might be involved.

The exemplary systems or methods of the present inventions may be developed using standard web-based technologies having options for members-only access. Other technology developments are possible. What is needed is a state-of-the-art electronic marketplace for the infrastructure community. An established technology platform reduces risk and assures continued state-of-the-art functionality. An exemplary system according to the present invention will utilize one of the leading B2B platforms for the exchange. The selected platform will provide for the greatest flexibility to add additional services, as customer needs change.

As described above, the present invention is focused on providing an e-commerce solution to workflow management. Project sponsors, EPCs, SPCs, and vendors within the market presently use very inefficient methods to bring a project from inception to operation. The exchange according to the present invention will provide tools for better workflow management and access to knowledge by providing a global marketplace for member users.

The present invention will provide simple access where access is presently very limited. This access will help the larger companies reduce costs and make more informed decisions, while assisting the smaller companies gain knowledge and exposure where none was previously available. Overall, the present invention will help the entire infrastructure community become more knowledgeable, more efficient and more accessible. Access will create more competition between vendors; thus, benefiting the purchaser. The market advantage is the exchange creates a win-win for all members.

The present invention reduces costs associated with doing business in a given region and/or market segment. Using the previously cited non-limiting example relating to the infrastructure industry in Latin America and the Caribbean, the effect of this invention is considered. The market for infrastructure in Latin America and the Caribbean increased from $73 billion in 1998 to $97 billion in 1999. There are two major segments in this market—Public Sector Entities and Private Sector Entities. For the Public Sector Entities, the advantage of the exchange is that it allows them to promote their infrastructure projects in world markets. Presently, they incur a high cost in promoting these projects. The process of printing and delivering the requests for proposal and communicating any changes creates great inefficiencies and tends to compress their markets. The exchange provides the vehicle to broader exposure, access to better service providers and increased competition for a more streamlined process and lower costs.

For the Private Sector Entities, the advantage of the exchange is that it provides access. These entities will use the exchange as a tool to locate projects, complete due diligence, locate international financial and business partners, identify local partners and suppliers and obtain expert information on specific issues and projects. The access to information for the small and medium sized entities will effectively level the playing field.

In this non-limiting example, the target geographical market on which this exchange will focus is Latin America and the Caribbean. The target market will consist of large governmental institutions that sponsor infrastructure projects and the small, medium and large entities that provide the services to complete such projects

A strategy for targeting participants is to approach some of the larger infrastructure players in Latin America and the Caribbean and obtain their commitment to use the exchange to list projects, etc. At the same time, the present invention is targeting smaller organizations from the buyer side to get their commitment to use the exchange. As the marketplace grows and becomes established, this dual effort on the supplier and buyer side will provide the momentum for the exchange to grow on its own.

The Latin America and Caribbean infrastructure market is very fragmented and the access to information is limited and costly to obtain. There are significant barriers to entry because of the cost of obtaining the relevant information and making the appropriate contacts in the community.

It is estimated that the present manner for bringing a project through the value chain adds approximately 30% to the cost of the project. The present invention will give the Latin America and Caribbean infrastructure community a tool to reduce these costs as well as the costs of design, construction and operation through increased competition and a more streamlined process.

The most significant market trend is that the power of the Internet has resulted in the emergence of centralized marketplace where businesses can buy and sell goods and services from each other. Based on the ability to bring buyers and sellers together on-line, these Internet exchanges are revolutionizing the existing concept of “doing business.” By exploiting the unique nature of the Internet, these exchanges facilitate the connecting of buyers and sellers and the generation of market pricing for products and services. The emerging markets do not have any such established exchanges.

The exchange's main value proposition is assisting in the management of workflow and providing access to knowledge. The exchange will be tailored to match the distinct characteristics of the Latin American and Caribbean markets. It offers an efficient, relatively inexpensive way for entities within Latin America and the Caribbean infrastructure market to conduct their business.

The illustrated exemplary embodiment of the present invention's competitive edge is that the Latin Americas and Caribbean infrastructure community has a very inefficient means for doing business. The current distribution channels are costly and the end users are limited because there tend to be geographic barriers to obtaining such information about projects being considered. The exchange will provide global access to such information that will allow for more competition for services and access on both the buyer and seller side to the projects and the best service providers at the most competitive prices.

Other potential infrastructure exchanges may be developed according to region and/or industry sector, focusing on those regions and/or sectors and the issues that affect their markets. It will be developed to meet their needs and will be in their languages. The member community will take a level of ownership of the exchange because it is targeted to them alone.

The exchange will succeed because it provides the infrastructure community with a more efficient means to manage the workflow process. The present invention provides access to global sources of information about infrastructure issues that are currently unavailable in the marketplace.

To fund the exchange operation according to an exemplary embodiment of the present invention, operators of such an exchange may charge an annual fixed fee membership for each of the several levels of membership, for example, three. Each tier of membership will provide varying levels of service and benefits relative to the fee paid. A user fee will also be assessed based on number of users per entity. The exchange may charge non-members a fee to list projects on the exchange. Member institutions in the first tier may be able to list projects with no cost. The exchange may charge members for intelligence reports, statistical reports, project alerts, project and company ratings based on their respective level of membership.

The exchange may charge fees to members for hosting storefronts on the exchange (primarily the lower tier members), and for classified listing of employment opportunities and services available. Furthermore, for a one-time commission, the exchange may allow 3^{rd} party consultants and content providers to offer for sale their reports to exchange members.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations. In addition, the method and/or process of the present invention should not be limited to the performance of their steps in the order written, and one skilled in the art can readily appreciate that the sequences may be varied and still remain within the spirit and scope of the present invention.

What is claimed is:

1. A method of information exchange comprising:
receiving project information from a first entity;
storing the project information;
displaying the project information for review by other entities;
receiving input from a second entity in response to the project information;
storing the input;
displaying the input for review and selection by the first entity.

2. The method of claim 1, wherein the input includes at least one of financing, contracting, subcontracting, and regulatory requirements.

3. The method of claim 1, further comprising sorting the project information for display based on geographical criteria.

4. The method of claim 3, wherein the geographical criteria comprises geographic regions.

5. The method of claim 4, wherein the geographic regions are chosen from at least one of Africa, Middle East, Latin America, Asia, Central Europe, Eastern Europe, and North America.

6. The method of claim 1, further comprising sorting the project information for display based on sector criteria.

7. The method of claim 6, wherein the sector criteria are chosen from at least one of tourism, finance, infrastructure, and technology.

8. A system for information exchange, comprising:
a sever having a memory;
receiving project information from a first entity and storing the project information in the memory;
displaying the project information for review by one or more second entities;
receiving inputs from the one or more second entities responding to the first entity's project information, offering to fulfill one or more of the inputs;
storing the inputs in the memory;
displaying the inputs for review and selection by the first user.

9. The system of claim 8, wherein the inputs include at least one of financing, contracting, subcontracting, and regulatory requirements.

10. The system of claim 8, wherein users are charged a fee to access the system.

11. The system of claim 8, wherein the system is accessible via a handheld computing device.

12. The system of claim 8, wherein the project information stored in the memory is sorted for display based on geographical criteria.

13. The system of claim 12, wherein the geographical criteria comprises geographic regions.

14. The system of claim 13, wherein the geographic regions are chosen from at least one of Africa, Middle East, Latin America, Asia, Central Europe, Eastern Europe, and North America.

15. The system of claim 8, wherein the project plans information stored in the memory is sorted for display based on sector criteria.

16. The system of claim 15, wherein the sector criteria are chosen from at least one of tourism, finance, infrastructure, and technology.

17. A method of operating an information exchange forum for allowing the exchange of information among a first group of users comprising institutions that offer infrastructure projects, a second group of users comprising companies that complete work directly with the first group of users in connection with the projects of the first group of users and a third group of users comprising smaller contractors and subcontractors that work collaboratively with the second group of users, the method comprising:
providing an electronic forum for information exchange;
providing the first group of users, the second group of users and the third group of users with secured access to the information exchange;
allowing users within the first group of users to list projects on the information exchange and update project terms and contacts for projects for which the first group users would like to bid out;
allowing users within the second group of users to bid on new projects, negotiate terms and track the on-going status of a project;
allowing users within the second group of users to receive bids from users within the third group of users so as to allow user within the second group of users to identify key prospective members of project syndicates.

18. The method of claim 17, further comprising archiving activity information and aggregating exchange intelligence information based on archived activity information.

19. The method of claim 17, further comprising providing, through the exchange, objective, third party industry advice from an expert with respect to a particular project.

20. The method of claim 17, further comprising allowing users to submit proposals for financing through the exchange to the relevant local, national or international financial institutions.
